(19) United States
(12) Patent Application Publication
(10) Pub. No.: US 2014/0101647 A1
(43) Pub. Date: Apr. 10, 2014

(54) Systems and Methods for Software Upgrade Recommendation

(71) Applicant: Tencent Technology (Shenzhen) Company Limited, Shenzhen (CN)

(72) Inventor: Qin Huang, Shenzhen (CN)

(73) Assignee: Tencent Technology (Shenzhen) Company Limited, Shenzhen (CN)

(21) Appl. No.: 14/102,556

(22) Filed: Dec. 11, 2013

Related U.S. Application Data
(63) Continuation of application No. PCT/CN2013/082895, filed on Sep. 4, 2013.

(30) Foreign Application Priority Data
Sep. 4, 2012 (CN) 201210323628.6

(51) Int. Cl. G06F 9/445

(52) U.S. Cl. CPC G06F 8/65
USPC 717/168

(57) ABSTRACT

Systems and methods are provided for software-upgrade recommendation. For example, use parameters or a white-list of upgrade volumes related to one or more software on a user terminal are acquired, the use parameters including use frequency or upgrade frequency related to the one or more software; a list of software-to-be-upgraded is generated based on at least information associated with the use parameters or the white-list of upgrade volume; and a list of recommended-software-upgrades for the user terminal is generated based on at least information associated with a comparison between the list of software-to-be-upgraded and a local software database.

### CROSS-REFERENCES TO RELATED APPLICATIONS

This application claims priority to Chinese Patent Application No. 201210323628.6, filed Sep. 4, 2012, incorporated by reference herein for all purposes.

### BACKGROUND OF THE INVENTION

The present invention is directed to computer technology. More particularly, the invention provides systems and methods for data processing. Merely by way of example, the invention has been applied to computer software. But it would be recognized that the invention has a much broader range of applicability.

Conventionally, software-upgrade recommendation is often provide based on records on a background server related to version numbers of one or more local software on a user terminal. When the version numbers of the software change, a client may compare the version numbers of the software to determine what software on the user terminal may need to be upgraded, and provide a notification to the user terminal for software upgrades.

FIG. 1 is a simplified diagram showing a conventional technique for software-upgrade recommendation. As shown in FIG. 1, a white-list 102 is often generated based on data associated with download-for-upgrade volumes of all software on a software-management client. The download-for-upgrade volumes of the software may be collected weekly and sorted in a descending order. A number of software (e.g., top 20 software) may be selected to a white-list 102. Then, the white list 102 may be compared with one or more local software databases 104 which correspond to different globally unique identifiers (GUIDs), so that one or more lists of software to be upgraded 106 may be generated for the different GUIDs. But the white-list 102 is established based on a ranking of the download-for-upgrade volumes of all software on the software-management client, which often cannot indicate individual software-upgrade patterns of different user terminals and the accuracy of the recommendation may be low.

Hence it is highly desirable to improve the technique for software-upgrade recommendation.

### BRIEF SUMMARY OF THE INVENTION

The present invention is directed to computer technology. More particularly, the invention provides systems and methods for data processing. Merely by way of example, the invention has been applied to computer software. But it would be recognized that the invention has a much broader range of applicability.

According to one embodiment, a method is provided for software-upgrade recommendation. For example, use parameters or a white-list of upgrade volumes related to one or more software on a user terminal are acquired, the use parameters including use frequency or upgrade frequency related to the one or more software; a list of software-to-be-upgraded is generated based on at least information associated with the use parameters or the white-list of upgrade volume; and a list of recommended-software-upgrades for the user terminal is generated based on at least information associated with a comparison between the list of software-to-be-upgraded and a local software database.

According to another embodiment, a device for software-upgrade recommendation includes a data-acquisition module, a first list-generation module, and a second list-generation module. The data-acquisition module is configured to acquire use parameters or a white-list of upgrade volumes related to one or more first software on a user terminal, the use parameters including use frequency or upgrade frequency related to the one or more first software. The first list-generation module is configured to generate a list of software-to-be-upgraded based on at least information associated with the use parameters or the white-list of upgrade volume. The second list-generation module is configured to generate a list of recommended-software-upgrades for the user terminal based on at least information associated with a comparison between the list of software-to-be-upgraded and a local software database.

According to yet another embodiment, a processor-implemented method is provided for software-upgrade recommendation. For example, use parameters or a white-list of upgrade volumes related to one or more first software on a user terminal are acquired, the use parameters including use frequency or upgrade frequency related to the one or more first software; a list of software-to-be-upgraded is generated based on at least information associated with the use parameters or the white-list of upgrade volume; the list of software-to-be-upgraded is sorted using a Fourier algorithm, a Bayesian algorithm or a weight algorithm; the sorted list of software-to-be-upgraded is compared with the local software database on the user terminal; one or more second software from the sorted list of software-to-be-upgraded is deleted in response to the one or more second software being not included in the local software database; a list of recommended-software-upgrades is generated based on at least information associated with a descending order of priority related to one or more third software remaining in the sorted list of software-to-be-upgraded; and the generated list of recommended-software-upgrades is provided to the user terminal. A timing database is searched to determine a last time when a start-up file of the one or more first software is run. The use frequency related to the one or more first software is acquired based on at least information associated with a comparison between the last time and a current local time. The upgrade frequency related to the one or more first software is acquired by searching records on a background server associated with software upgrades on the user terminal.

In one embodiment, a device for software-upgrade recommendation includes a data-acquisition module, a first list-generation module, a sorting module and a second list-generation module. The data-acquisition module is configured to acquire use parameters or a white-list of upgrade volumes related to one or more first software on a user terminal, the use parameters including use frequency or upgrade frequency related to the one or more first software. The first list-generation module is configured to generate a list of software-to-be-upgraded based on at least information associated with the use parameters or the white-list of upgrade volume. The sorting module is configured to sort the list of software-to-be-upgraded using a Fourier algorithm, a Bayesian algorithm or a weight algorithm. The second list-generation module is configured to compare the sorted list of software-to-be-upgraded with the local software database on the user terminal, delete one or more second software from the sorted list of software-to-be-upgraded in response to the one or more second software being not included in the local software database, generate a list of recommended-software-upgrades based on at least information associated with a descending order of priority related to one or more third software remaining in the sorted list of software-to-be-upgraded, and provide the generated list of recommended-software-upgrades to the user terminal. A timing database is searched to determine a last time when a start-up file of the one or more first software is run. The use frequency related to the one or more first software is acquired based on at least information associated with a comparison between the last time and a current local time. The upgrade frequency related to the one or more first software is acquired by searching records on a background server associated with software upgrades on the user terminal.

In another embodiment, a non-transitory computer readable storage medium includes programming instructions for software-upgrade recommendation, the programming instructions configured to cause one or more data processors to execute certain operations. For example, use parameters or a white-list of upgrade volumes related to one or more software on a user terminal are acquired, the use parameters including use frequency or upgrade frequency related to the one or more software; a list of software-to-be-upgraded is generated based on at least information associated with the use parameters or the white-list of upgrade volume; and a list of recommended-software-upgrades for the user terminal is generated based on at least information associated with a comparison between the list of software-to-be-upgraded and a local software database.

In yet another embodiment, a computer-implemented system for software-upgrade recommendation includes one or more data processors and a computer-readable storage medium. The storage medium is encoded with instructions for commanding the data processors to execute certain operations. For example, use parameters or a white-list of upgrade volumes related to one or more software on a user terminal are acquired, the use parameters including use frequency or upgrade frequency related to the one or more software; a list of software-to-be-upgraded is generated based on at least information associated with the use parameters or the white-list of upgrade volume; and a list of recommended-software-upgrades for the user terminal is generated based on at least information associated with a comparison between the list of software-to-be-upgraded and a local software database.

For example, the systems and methods described herein may be configured to determine whether one or more software needs to be upgraded for a user terminal based on at least information associated with data related to use frequency of the software and data related to upgrade frequency of the software through a software-management client so as to dynamically recommend software upgrades to the user terminal in a more accurate and intelligent manner.

Depending upon embodiment, one or more benefits may be achieved. These benefits and various additional objects, features and advantages of the present invention can be fully appreciated with reference to the detailed description and accompanying drawings that follow.

### BRIEF DESCRIPTION OF THE DRAWINGS

FIG. 1 is a simplified diagram showing a conventional technique for software-upgrade recommendation;

FIG. 2 is a simplified diagram showing a method for software-upgrade recommendation according to one embodiment of the present invention;

FIG. 3 is a simplified diagram showing a method for software-upgrade recommendation according to another embodiment of the present invention;

FIG. 4 is a simplified diagram for software-upgrade recommendation according to one embodiment of the present invention;

FIG. 5 is a simplified diagram of a device for software-upgrade recommendation according to one embodiment of the present invention; and

FIG. 6 is a simplified diagram of a device for software-upgrade recommendation according to another embodiment of the present invention.

### DETAILED DESCRIPTION OF THE INVENTION

The present invention is directed to computer technology. More particularly, the invention provides systems and methods for data processing. Merely by way of example, the invention has been applied to computer software. But it would be recognized that the invention has a much broader range of applicability.

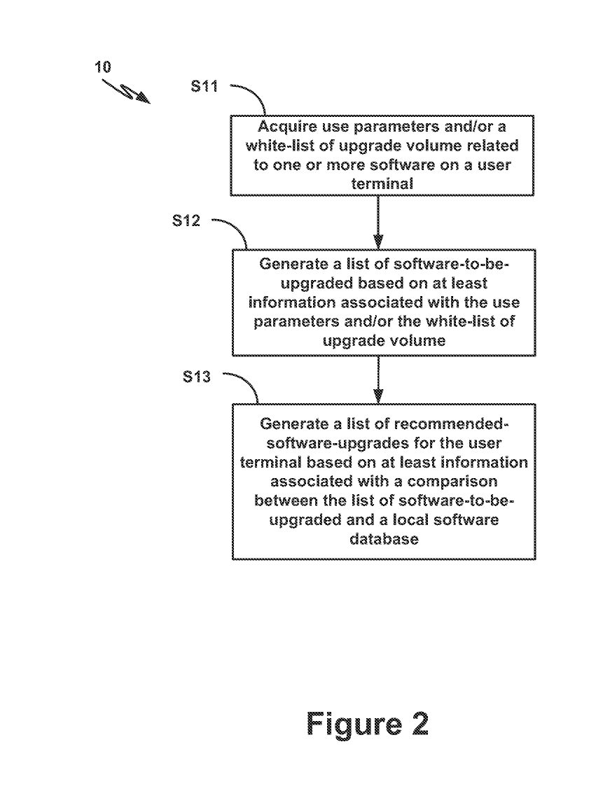

FIG. 2 is a simplified diagram showing a method for software-upgrade recommendation according to one embodiment of the present invention. This diagram is merely an example, which should not unduly limit the scope of the claims. One of ordinary skill in the art would recognize many variations, alternatives, and modifications. The method 10 includes at least the process S11 for acquiring use parameters and/or a white-list of upgrade volumes related to one or more software on a user terminal, where the use parameters includes use frequency and/or upgrade frequency related to the one or more software, the process S12 for generating a list of software-to-be-upgraded based on at least information associated with the use parameters and/or the white-list of upgrade volume, and the process S13 for generating a list of recommended-software-upgrades for the user terminal based on at least information associated with a comparison between the list of software-to-be-upgraded and a local software database.

According to one embodiment, a software-management client and/or a background data-reporting mechanism may be used to acquire multiple use parameters, such as the use frequency and/or the upgrade frequency of certain software on the user terminal. For example, the use parameters may be implemented for calculating a list of recommended-software-upgrades for the user terminal based on one or more algorithms. As an example, a user terminal may include a personal computer, a personal digital assistant, a set-top box connected to a television, a cellular telephone, or any other electronic devices that may be used for running certain software.

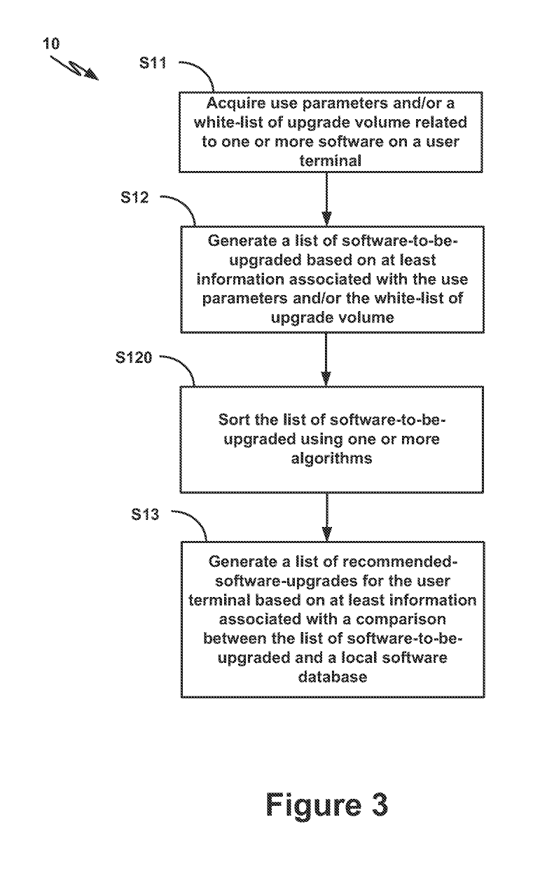

FIG. 3 is a simplified diagram showing the method 10 for software-upgrade recommendation according to another embodiment of the present invention. This diagram is merely an example, which should not unduly limit the scope of the claims. One of ordinary skill in the art would recognize many variations, alternatives, and modifications. In addition to the processes shown in FIG. 2, the method 10 further includes a process S120. In some embodiments, the process S120 includes sorting the list of software-to-be-upgraded using one or more algorithms, for example, a Fourier algorithm, a Bayesian algorithm, a weight algorithm, or a combination thereof.

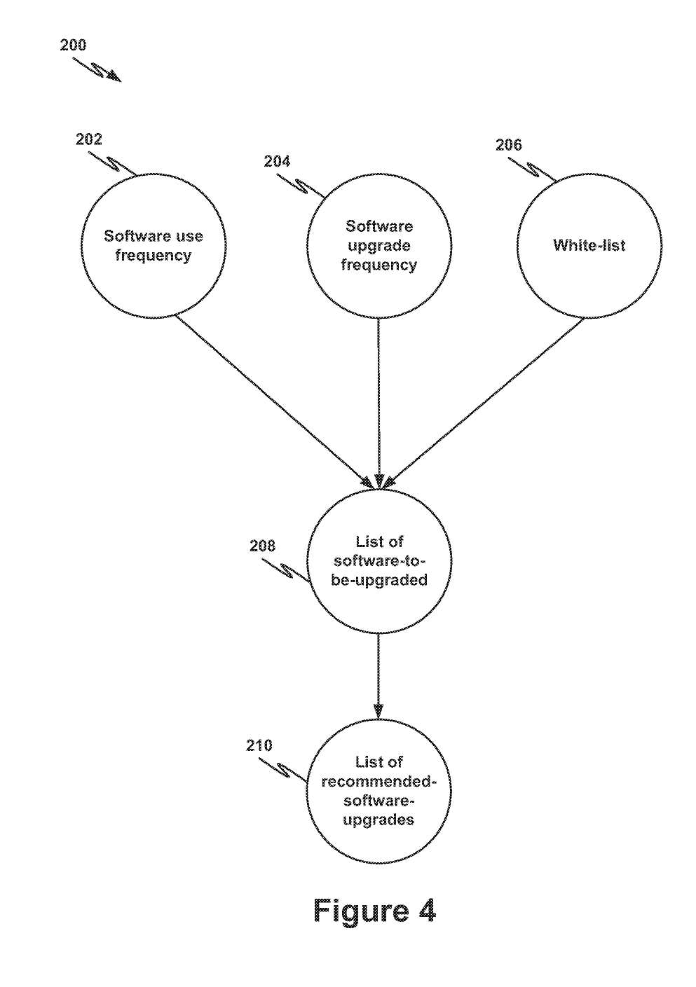

FIG. 4 is a simplified diagram for software-upgrade recommendation according to one embodiment of the present invention. This diagram is merely an example, which should not unduly limit the scope of the claims. One of ordinary skill in the art would recognize many variations, alternatives, and modifications. As shown in FIG. 4, data associated with software use frequency 202 (e.g., collected from a software-management client), data associated with software upgrade frequency 204 (e.g., collected from records of a background server), and data associated with a white-list of upgrade volumes 206 (e.g., top 20) are used for generating a list of software-to-be-upgraded 208 (e.g., corresponding to one or more GUIDs), in certain embodiments.

According to one embodiment, the software use frequency is determined using a timing database (e.g., sqlite, a light database) which records times at which start-up files (e.g., .exe files) of certain local software are most recently run. As an example, the timing database is searched to determine a last time when a start-up file of a particular software is run, and the located last time is compared with a current local time to determine the use frequency of the particular software. For example, if the difference between the located last time and the current local time is smaller than three days, the particular software is determined to be a frequently-used software; if the difference is smaller than seven days, the particular software is determined to be an occasionally-used software; if the difference is smaller than thirty days, the particular software is determined to be a seldom-used software; and if the difference is larger than thirty days, the particular software is determined to be a never-used software. The frequently-used software is all included in the list of software-to-be-upgraded 208, in some embodiments. In certain embodiments, a small number (e.g., top 5 or top 10) of frequently-used software is selected to the list of software-to-be-upgraded 208, for example, if the number of frequently-used software exceeds a threshold.

According to another embodiment, the software upgrade frequency is determined using a background server which includes records associated with software upgrades on a user terminal related to a QUID. For example, when a user upgrades certain software through a software-management client, the background server records that the software has been upgraded once (e.g., the upgrade record being set to “1”). When the user upgrades the software through the software-management client again, the background server records that the software has been upgraded twice (e.g., the upgrade record being set to “2”). As an example, the upgrade record is set to “0” if a software has never been upgraded. In some embodiments, a number of software with high upgrade frequencies (e.g., top 5 or top 10) is selected weekly to the list of software-to-be-upgraded 208 based on the records of software upgrades on the background server. According to yet another embodiment, a number of software with high upgrade volumes according to the software-management client is selected to the list of software-to-be-upgraded 208.

In one embodiment, the list of software-to-be-upgraded 208 is sorted using one or more algorithms, e.g., a Fourier algorithm, a Bayesian algorithm, a weight algorithm, or a combination thereof. For example, the sorted list of software-to-be-upgraded is compared with a local software database on the user terminal. In another example, if one or more software in the sorted list of software-to-be-upgraded is not included in the local software database on the user terminal, such software may be deleted from list of software-to-be-upgraded. In yet another example, the list of recommended-software-upgrades 210 is generated based on at least information associated with a descending order of priority related to the remaining software in the sorted list of software-to-be-upgraded. In yet another example, the generated list of recommended-software-upgrades 210 is provided to the user terminal.

In another embodiment, the list of software-to-be-upgraded 208 is sorted using a weight algorithm. For example, weights are assigned to different attributes (e.g., upgrade frequency, use frequency and/or download volume) of a software within the list of software-to-be-upgraded 208, and a weight ratio is calculated based on the weights assigned to the attributes of the software. As an example, the weight ratios of all software in the list of software-to-be-upgraded 208 are then used to sort the list of software-to-be-upgraded 208, and the sorted list is compared with the local software database on the user terminal. In another example, if one or more software in the sorted list of software-to-be-upgraded is not included in the local software database on the user terminal, such software may be deleted from list of software-to-be-upgraded. In yet another example, the list of recommended-software-upgrades 210 is generated based on at least information associated with a descending order of priority related to the remaining software in the sorted list of software-to-be-upgraded. In yet another example, the generated list of recommended-software-upgrades 210 is provided to the user terminal.

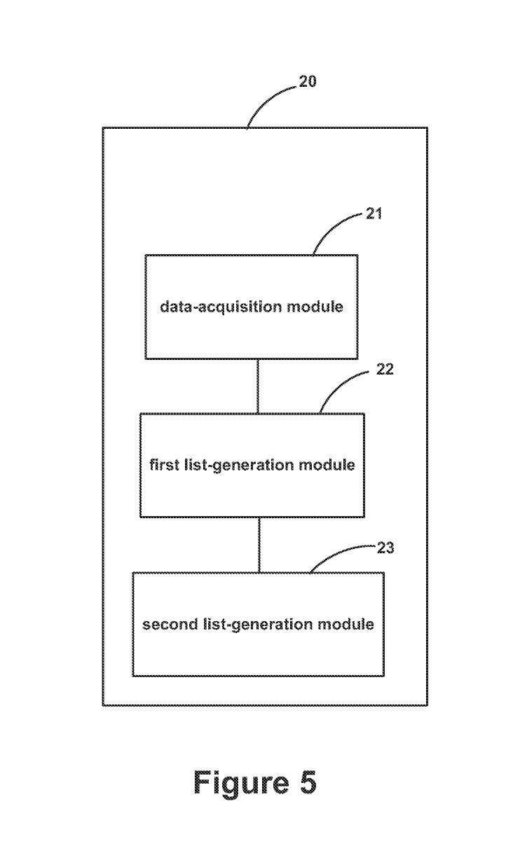

FIG. 5 is a simplified diagram of a device for software-upgrade recommendation according to one embodiment of the present invention. This diagram is merely an example, which should not unduly limit the scope of the claims. One of ordinary skill in the art would recognize many variations, alternatives, and modifications. The device 20 includes a data-acquisition module 21, a first list-generation module 22, and a second list-generation module 23.

According to one embodiment, the data-acquisition module 21 is configured to acquire use parameters and/or a white-list of upgrade volumes related to one or more software on a user terminal, where the use parameters include use frequency and/or upgrade frequency related to the one or more software. For example, the first list-generation module 22 is configured to generate a list of software-to-be-upgraded based on at least information associated with the use parameters and/or the white-list of upgrade volume. As an example, the second list-generation module 23 is configured to generate a list of recommended-software-upgrades for the user terminal based on at least information associated with a comparison between the list of software-to-be-upgraded and a local software database.

According to one embodiment, a software-management client and/or a background data reporting mechanism may be used to acquire multiple use parameters, such as the use frequency and/or the upgrade frequency of certain software on the user terminal. For example, the use parameters may be implemented for calculating a list of recommended-software-upgrades for the user terminal based on one or more algorithms. As an example, a user terminal may include a personal computer, a personal digital assistant, a set-top box connected to a television, a cellular telephone, or any other electronic devices that may be used for running certain software.

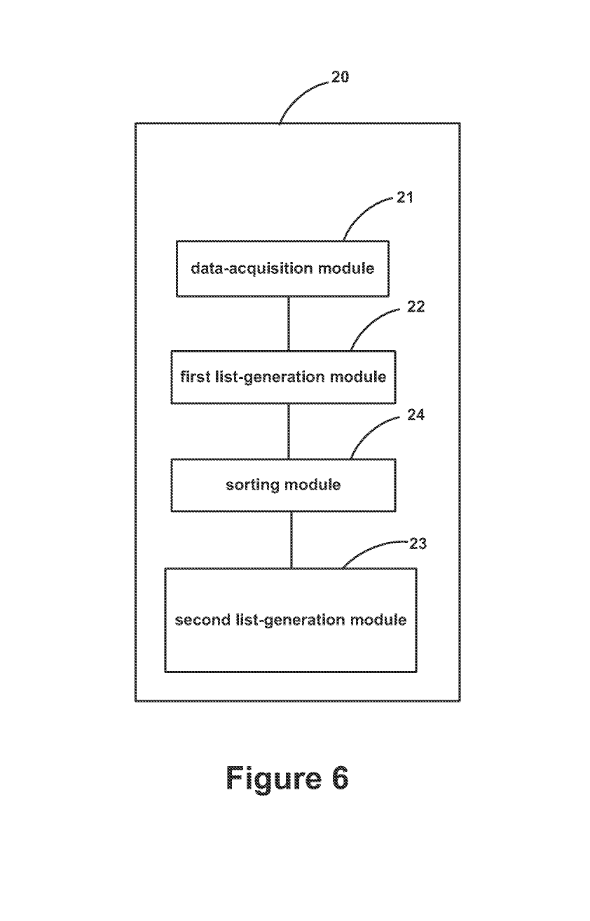

FIG. 6 is a simplified diagram of the device 20 for software-upgrade recommendation according to another embodiment of the present invention. This diagram is merely an example, which should not unduly limit the scope of the claims. One of ordinary skill in the art would recognize many variations, alternatives, and modifications. In addition to the modules shown in FIG. 5, the device 20 further includes a sorting module 24. In some embodiments, the sorting module is configured to sort the list of software-to-be-upgraded using one or more algorithms, for example, a Fourier algorithm, a. Bayesian algorithm, a weight algorithm, or a combination thereof.

The device 20 (e.g., as shown in FIG. 5 or FIG. 6) performs software-upgrade recommendation according to FIG. 4, in some embodiments. According to one embodiment, the software use frequency is determined using a timing database (e.g., sqlite, a light database) which records times at which start-up files (e.g., .exe files) of certain local software are last run. As an example, the timing database is searched to determine a last time when a start-up file of a particular software is run, and the located last time is compared with a current local time to determine the use frequency of the particular software. For example, if the difference between the located last time and the current local time is smaller than three days, the particular software is determined to be a frequently-used software; if the difference is smaller than seven days, the particular software is determined to be an occasionally-used software; if the difference is smaller than thirty days, the particular software is determined to be a seldom-used software; and if the difference is larger than thirty days, the particular software is determined to be a never-used software. The frequently-used software is all included in the list of software-to-be-upgraded 208, in some embodiments. In certain embodiments, a small number (e.g., top 5 or top 10) of frequently-used software is selected to the list of software-to-be-upgraded 208, for example, if the number of frequently-used software exceeds a threshold.

According to another embodiment, the software upgrade frequency is determined using a background server which includes records associated with software upgrades on a user terminal related to a GUID. For example, when a user upgrades certain software through a software-management client, the background server records that the software has been upgraded once (e.g., the upgrade record being set to “1”). When the user upgrades the software through the software-management client again, the background server records that the software has been upgraded twice (e.g., the upgrade record being set to “2”). As an example, the upgrade record is set to “0” if a software has never been upgraded. In some embodiments, a number of software with high upgrade frequencies (e.g., top 5 or top 10) is selected weekly to the list of software-to-be-upgraded 208 based on the records of software upgrades on the background server. According to yet another embodiment, a number of software with high upgrade volumes according to the software-management client is selected to the list of software-to-be-upgraded 208.

In one embodiment, the list of software-to-be-upgraded 208 is sorted using one or more algorithms, e.g., a Fourier algorithm, a Bayesian algorithm, a weight algorithm, or a combination thereof. For example, the sorted list of software-to-be-upgraded is compared with a local software database on the user terminal. In another example, if one or more software in the sorted list of software-to-be-upgraded is not included in the local software database on the user terminal, such software may be deleted from list of software-to-be-upgraded. In yet another example, the list of recommended-software-upgrades 210 is generated based on at least information associated with a descending order of priority related to the remaining software in the sorted list of software-to-be-upgraded. In yet another example, the generated list of recommended-software-upgrades 210 is provided to the user terminal.

In another embodiment, the list of software-to-be-upgraded 208 is sorted using a weight algorithm. For example, weights are assigned to different attributes (e.g., upgrade frequency, use frequency and/or download volume) of a software within the list of software-to-be-upgraded 208, and a weight ratio is calculated based on the weights assigned to the attributes of the software. As an example, the weight ratios of all software in the list of software-to-be-upgraded 208 are then used to sort the list of software-to-be-upgraded 208, and the sorted list is compared with the local software database on the user terminal. In another example, if one or more software in the sorted list of software-to-be-upgraded is not included in the local software database on the user terminal, such software may be deleted from list of software-to-be-upgraded. In yet another example, the list of recommended-software-upgrades 210 is generated based on at least information associated with a descending order of priority related to the remaining software in the sorted list of software-to-be-upgraded. In yet another example, the generated list of recommended-software-upgrades 210 is provided to the user terminal.

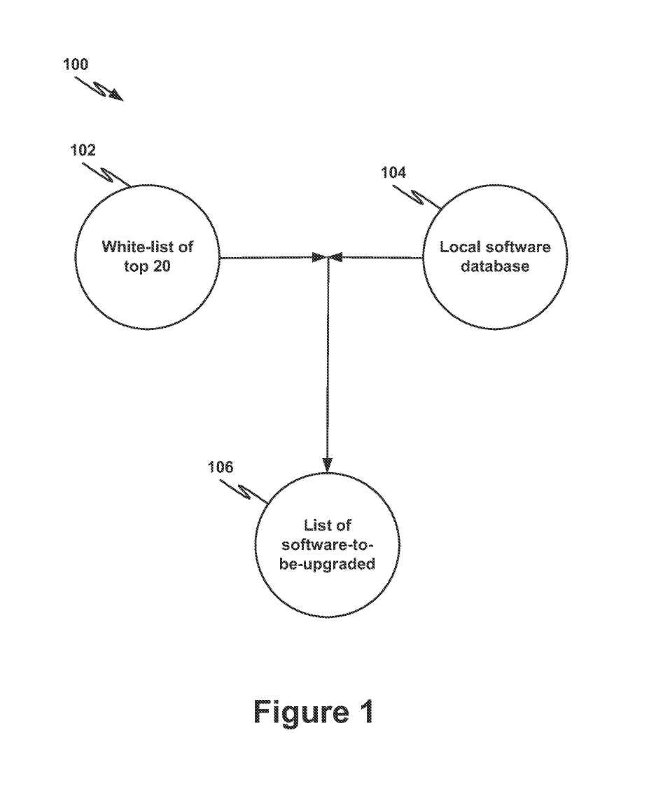

According to one embodiment, a method is provided for software-upgrade recommendation. For example, use parameters or a white-list of upgrade volumes related to one or more software on a user terminal are acquired, the use parameters including use frequency or upgrade frequency related to the one or more software; a list of software-to-be-upgraded is getter based on at least information associated with the use parameters or the white-list of upgrade volume; and a list of recommended-software-upgrades for the user terminal is generated based on at least information associated with a comparison between the list of software-to-be-upgraded and a local software database. For example, the method is implemented according to at least FIG. 1, FIG. 2, FIG. 3, and/or FIG. 4.

According to another embodiment, a device for software-upgrade recommendation includes a data-acquisition module, a first list-generation module, and a second list-generation module. The data-acquisition module is configured to acquire use parameters or a white-list of upgrade volumes related to one or more first software on a user terminal, the use parameters including use frequency or upgrade frequency related to the one or more first software. The first list-generation module is configured to generate a list of software-to-be-upgraded based on at least information associated with the use parameters or the white-list of upgrade volume. The second list-generation module is configured to generate a list of recommended-software-upgrades for the user terminal based on at least information associated with a comparison between the list of software-to-be-upgraded and a local software database. For example, the device is implemented according to at least FIG. 4, FIG. 5, and/or FIG. 6.

According to yet another embodiment, a processor-implemented method is provided for software-upgrade recommendation. For example, use parameters or a white-list of upgrade volumes related to one or more first software on a user terminal are acquired, the use parameters including use frequency or upgrade frequency related to the one or more first software; a list of software-to-be-upgraded is generated based on at least information associated with the use parameters or the white-list of upgrade volume; the list of software-to-be-upgraded is sorted using a Fourier algorithm, a Bayesian algorithm or a weight algorithm; the sorted list of software-to-be-upgraded is compared with the local software database on the user terminal; one or more second software from the sorted list of software-to-be-upgraded is deleted in response to the one or more second software being not included in the local software database; a list of recommended-software-upgrades is generated based on at least information associated with a descending order of priority related to one or more third software remaining in the sorted list of software-to-be-upgraded; and the generated list of recommended-software-upgrades is provided to the user terminal. A timing database is searched to determine a last time when a start-up file of the one or more first software is run. The use frequency related to the one or more first software is acquired based on at least information associated with a comparison between the last time and a current local time. The upgrade frequency related to the one or more first software is acquired by searching records on a background server associated with software upgrades on the user terminal. For example, the method is implemented according to at least FIG. 1, FIG. 2, FIG. 3, and/or FIG. 4.

In one embodiment, a device for software-upgrade recommendation includes a data-acquisition module, a first list-generation module, a sorting module and a second list-generation module. The data-acquisition module is configured to acquire use parameters or a white-list of upgrade volumes related to one or more first software on a user terminal, the use parameters including use frequency or upgrade frequency related to the one or more first software. The first list-generation module is configured to generate a list of software-to-be-upgraded based on at least information associated with the use parameters or the white-list of upgrade volume. The sorting module is configured to sort the list of software-to-be-upgraded using a Fourier algorithm, a Bayesian algorithm or a weight algorithm. The second list-generation module is configured to compare the sorted list of software-to-be-upgraded with the local software database on the user terminal, delete one or more second software from the sorted list of software-to-be-upgraded in response to the one or more second software being not included in the local software database, generate a list of recommended-software-upgrades based on at least information associated with a descending order of priority related to one or more third software remaining in the sorted list of software-to-be-upgraded, and provide the generated list of recommended-software-upgrades to the user terminal A timing database is searched to determine a last time when a start-up file of the one or more first software is run. The use frequency related to the one or more first software is acquired based on at least information associated with a comparison between the last time and a current local time. The upgrade frequency related to the one or more first software is acquired by searching records on a background server associated with software upgrades on the user terminal For example, the device is implemented according to FIG. 1, FIG. 2, FIG. 3, FIG. 4, FIG. 5, and/or FIG. 6.

In another embodiment, a non-transitory computer readable storage medium includes programming instructions for software-upgrade recommendation, the programming instructions configured to cause one or more data processors to execute certain operations. For example, use parameters or a white-list of upgrade volumes related to one or more software on a user terminal are acquired, the use parameters including use frequency or upgrade frequency related to the one or more software; a list of software-to-be-upgraded is generated based on at least information associated with the use parameters or the white-list of upgrade volume; and a list of recommended-software-upgrades for the user terminal is generated based on at least information associated with a comparison between the list of software-to-be-upgraded and a local software database. For example, the storage medium is implemented according to FIG. 1, FIG. 2, FIG. 3, FIG. 4, FIG. 5, and/or FIG. 6.

In yet another embodiment, a computer-implemented system for software-upgrade recommendation includes one or more data processors and a computer-readable storage medium. The storage medium is encoded with instructions for commanding the data processors to execute certain operations. For example, use parameters or a white-list of upgrade volumes related to one or more software on a user terminal are acquired, the use parameters including use frequency or upgrade frequency related to the one or more software; a list of software-to-be-upgraded is generated based on at least information associated with the use parameters or the white-list of upgrade volume; and a list of recommended-software-upgrades for the user terminal is generated based on at least information associated with a comparison between the list of software-to-be-upgraded and a local software database. For example, the system is implemented according to FIG. 1, FIG. 2, FIG. 3, FIG. 4, FIG. 5, and/or FIG. 6.

The above only describes several scenarios presented by this invention, and the description is relatively specific and detailed, yet it cannot therefore be understood as limiting the scope of this invention's patent. It should be noted that ordinary technicians in the field may also, without deviating from the invention's conceptual premises, make a number of variations and modifications, which are all within the scope of this invention. As a result, in terms of protection, the patent claims shall prevail.

For example, some or all components of various embodiments of the present invention each are, individually and/or in combination with at least another component, implemented using one or more software components, one or more hardware components, and/or one or more combinations of software and hardware components. In another example, some or all components of various embodiments of the present invention each are, individually and/or in combination with at least another component, implemented in one or more circuits, such as one or more analog circuits and/or one or more digital circuits. In yet another example, various embodiments and/or examples of the present invention can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, fiat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, etc.) that contain instructions (e.g., software) for use in execution by a processor to perform the methods' operations and implement the systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope or of what may be claimed, but rather as descriptions of features specific to particular embodiments. Certain features that are described in this specification in the context or separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

1. A processor-implemented method for software-upgrade recommendation, the method comprising:
acquiring, using one or more data processors, use parameters or a white-list of upgrade volumes related to one or more first software on a user terminal, the use parameters including use frequency or upgrade frequency related to the one or more first software;
generating, using the one or more data processors, a list of software-to-be-upgraded based on at least information associated with the use parameters or the white-list of upgrade volume; and
generating, using the one or more data processors, a list of recommended-software-upgrades for the user terminal based on at least information associated with a comparison between the list of software-to-be-upgraded and a local software database.

2. The method of claim 1, further comprising:
sorting the list of software-to-be-upgraded using a Fourier algorithm, a Bayesian algorithm or a weight algorithm.

3. The method of claim 2 wherein the generating a list of recommended-software-upgrades for the user terminal based on at least information associated with a comparison between the list of software-to-be-upgraded and a local software database includes:
comparing the sorted list of software-to-be-upgraded with the local software database on the user terminal;
deleting one or more second software from the sorted list of software-to-be-upgraded in response to the one or more second software being not included in the local software database;
generating the list of recommended-software-upgrades based on at least information associated with a descending order of priority related to one or more third software remaining in the sorted list of software-to-be-upgraded; and
providing the generated list of recommended-software-upgrades to the user terminal.

4. The method of claim 1 wherein:
a timing database is searched to determine a last time when a start-up file of the one or more first software is run; and
the use frequency related to the one or more first software is acquired based on at least information associated with a comparison between the last time and a current local time.

5. The method of claim 1 wherein the upgrade frequency related to the one or more first software is acquired by searching records on a background server associated with software upgrades on the user terminal.

6. The method of claim 1 wherein the use parameters and the white-list of upgrade volumes related to the one or more first software on the user terminal are acquired.

7. The method of claim 1 wherein the use parameters includes the use frequency and the upgrade frequency related to the one or more first software.

8. The method of claim 1 wherein the list of software-to-be-upgraded is generated based on at least information associated with the use parameters and the white-list of upgrade volume.

9. A device for software-upgrade recommendation, the device comprising:
a data-acquisition module configured to acquire use parameters or a white-list of upgrade volumes related to one or more first software on a user terminal, the use parameters including use frequency or upgrade frequency related to the one or more first software;
a first list-generation module configured to generate a list of software-to-be-upgraded based on at least information associated with the use parameters or the white-list of upgrade volume; and
a second list-generation module configured to generate a list of recommended-software-upgrades for the user terminal based on at least information associated with a comparison between the list of software-to-be-upgraded and a local software database.

10. The device of claim 9, further comprising:
a sorting module configured to sort the list of software-to-be-upgraded using a Fourier algorithm, a Bayesian algorithm or a weight algorithm.

11. The device of claim 10 wherein the second list-generation module is further configured to:
compare the sorted list of software-to-be-upgraded with the local software database on the user terminal;
delete one or more second software from the sorted list of software-to-be-upgraded in response to the one or more second software being not included in the local software database;
generate the list of recommended-software-upgrades based on at least information associated with a descending order of priority related to one or more third software remaining in the sorted list of software-to-be-upgraded; and
provide the generated list of recommended-software-upgrades to the user terminal.

12. The device of claim 9 wherein:
a timing database is searched to determine a last time when a start-up file of the one or more first software is run; and
the use frequency related to the one or more first software is acquired based on at least information associated with a comparison between the last time and a current local time.

13. The device of claim 9 wherein the upgrade frequency related to the one or more first software is acquired by searching records on a background server associated with software upgrades on the user terminal.

14. The device of claim 9 wherein the use parameters and the white-list of upgrade volumes related to the one or more first software on the user terminal are acquired.

15. The device of claim 9 wherein the use parameters includes the use frequency and the upgrade frequency related to the one or more first software.

16. The device of claim 9 wherein the list of software-to-be-upgraded is generated based on at least information associated with the use parameters and the white-list of upgrade volume.

17. The device of claim 9, further comprising:
one or more processors; and
a memory;
wherein the data-acquisition module, the first list-generation module and the second list-generation module are stored in the memory and configured to be executed by the one or more processors.

18. A processor-implemented method for software-upgrade recommendation, the method comprising:
acquiring, using one or more data processors, use parameters or a white-list of upgrade volumes related to one or more first software on a user terminal, the use parameters including use frequency or upgrade frequency related to the one or more first software;
generating, using the one or more data processors, a list of software-to-be-upgraded based on at least information associated with the use parameters or the white-list of upgrade volume;
sorting the list of software-to-be-upgraded using a Fourier algorithm, a Bayesian algorithm or a weight algorithm;
comparing the sorted list of software-to-be-upgraded with the local software database on the user terminal;
deleting one or more second software from the sorted list of software-to-be-upgraded in response to the one or more second software being not included in the local software database;
generating a list of recommended-software-upgrades based on at least information associated with a descending order of priority related to one or more third software remaining in the sorted list of software-to-be-upgraded; and
providing the generated list of recommended-software-upgrades to the user terminal;
wherein:
a timing database is searched to determine a last time when a start-up file of the one or more first software is run;
the use frequency related to the one or more first software is acquired based on at least information associated with a comparison between the last time and a current local time; and
the upgrade frequency related to the one or more first software is acquired by searching records on a background server associated with software upgrades on the user terminal.

19. A device for software-upgrade recommendation, the device comprising:
a data-acquisition module configured to acquire use parameters or a white-list of upgrade volumes related to one or more first software on a user terminal, the use parameters including use frequency or upgrade frequency related to the one or more first software;
a first list-generation module configured to generate a list of software-to-be-upgraded based on at least information associated with the use parameters or the white-list of upgrade volume;
a sorting module configured to sort the list of software-to-be-upgraded using a Fourier algorithm, a Bayesian algorithm or a weight algorithm; and
a second list-generation module configured to:
compare the sorted list of software-to-be-upgraded with the local software database on the user terminal;
delete one or more second software from the sorted list of software-to-be-upgraded in response to the one or more second software being not included in the local software database;
generate a list of recommended-software-upgrades based on at least information associated with a descending order of priority related to one or more third software remaining in the sorted list of software-to-be-upgraded; and
provide the generated list of recommended-software-upgrades to the user terminal;
wherein:
a timing database is searched to determine a last time when a start-up file of the one or more first software is run;
the use frequency related to the one or more first software is acquired based on at least information associated with a comparison between the last time and a current local time; and
the upgrade frequency related to the one or more first software is acquired by searching records on a background server associated with software upgrades on the user terminal.

20. A non-transitory computer readable storage medium comprising programming instructions for software-upgrade recommendation, the programming instructions configured to cause one or more data processors to execute operations comprising:
acquiring use parameters or a white-list of upgrade volumes related to one or more software on a user terminal, the use parameters including use frequency or upgrade frequency related to the one or more software;
generating a list of software-to-be-upgraded based on at least information associated with the use parameters or the white-list of upgrade volume; and
generating a list of recommended-software-upgrades for the user terminal based on at least information associated with a comparison between the list of software-to-be-upgraded and a local software database.

21. A computer-implemented system for software-upgrade recommendation, said system comprising:
one or more data processors; and
a computer-readable storage medium encoded with instructions for commanding the data processors to execute operations including:
acquiring use parameters or a white-list of upgrade volumes related to one or more software on a user terminal, the use parameters including use frequency or upgrade frequency related to the one or more software;
generating a list of software-to-be-upgraded based on at least information associated with the use parameters or the white-list of upgrade volume; and
generating a list of recommended-software-upgrades for the user terminal based on at least information associated with a comparison between the list of software-to-be-upgraded and a local software database.
